(19) United States
(12) Patent Application Publication
(10) Pub. No.: US 2014/0344043 A1
(43) Pub. Date: Nov. 20, 2014

(54) Methods and Systems for Converting Paper Coupons To Electronic Coupons and Subsequently Managing Paper and Electronic Coupons From Manufacturer to Customer to Retailer and Back to Manufacturer Also Known As A Coupon Management System

(71) Applicants: Evelyn Elaine Hennessy, Wake Forest, NC (US); Jeremy Scott Powell, Raleigh, NC (US)

(72) Inventors: Evelyn Elaine Hennessy, Wake Forest, NC (US); Jeremy Scott Powell, Raleigh, NC (US)

(21) Appl. No.: 14/272,696

(22) Filed: May 8, 2014

Related U.S. Application Data
(60) Provisional application No. 61/824,801, filed on May 17, 2013.

(51) Int. Cl. G06Q 30/02

(52) U.S. Cl. CPC G06Q 30/0225; G06Q 30/0235
USPC 705/14.26

(57) ABSTRACT

Methods and systems for managing both electronic and paper coupons that includes a coupon web application and coupon card that allows paper coupons to be electronic, paperless, easily accessible, and organized with the use of mobile devices and wireless capable kiosk. Disclosed herein, the aforementioned printed and/or electronic coupons will have the ability to be loaded via web application to mobile device and/or scanned via wireless capable kiosk or personal home scanner. These same coupons will be placed in a user account via the web application and/or placed on a coupon card that will have the capability to be scanned by a retail UPC-type scanner for the process of being redeemed. This coupon web application and coupon card allows all coupons to be captured into one place, extracted effortlessly, notifies of expiration and allows better and easier utilization.

### CROSS REFERENCE TO RELATED APPLICATIONS

This application is a non-provisional application claiming priority from U.S. Provisional Application No. U.S. 61/824,801 filed May 17, 2013.

All of the above-cited applications are incorporated herein by reference in their entirety.

### FEDERALLY SPONSORED RESEARCH

Not applicable.

### SEQUENCE LISTING OR PROGRAM

Not applicable.

### BACKGROUND

### Prior Art

Consumers obtain paper coupons in a variety of ways. They may cut them out of a newspaper, receive them in the mail, or receive them at a Point of Service (POS) terminal when making a purchase. Sometimes paper coupons are mailed to consumers by the sponsor of the coupon or other entity. They also can receive them electronically through email accounts or by printing paper coupons off of the internet onto a home printer.

Paper coupons are cumbersome to keep track of and time consuming to maintain. Many consumers do not have time to clip paper coupons. Those who use a large number of paper coupons often spend additional time sorting the coupons into categories so that a particular coupon is easier to find. Further, consumers will often receive the paper coupon some time before they intend to use it. The consumer then stores the paper coupon until they go shopping. This makes coupons poorly utilized. Out of the 302 billion coupons distributed in the year 2012, less than 1% were utilized.

Conventional advertising still represents the largest chunk of the marketplace—about twice as much as digital media advertising in terms of total dollars spent. Thus, there is a need for a system that will assist merchants and manufacturers in making sure their marketing dollars are not being wasted and to allow consumers a way to manage their coupons so that they can save money and time. There is no prior art that converts already existing paper coupons into electronic coupons.

Prior art has not addressed utilizing paper coupons. Prior art deals with electronic coupons coming directly from the manufacturer and not having paper coupons at all. Not only would this mean jobs lost, it would mean that in order to save money all consumers will be forced to use electronic coupons. Technology continues to grow but consumers are creatures of habit. It appears that consumers are not ready to let go of paper coupons—in 2012, less than 2% of coupons redeemed were via a mobile device. The rest were paper coupons according to the 2013 Annual NCH Coupon Facts. There is a need to find a way to utilize the paper coupons in this ever-increasing electronic world. Free-standing inserts are the dominant coupon distribution method with an estimated 90% share of distribution by volume in 2012. Consumers need a way to still utilize paper coupons, but will give them a way to manage and utilize them more proficiently.

Offering a coupon management system that presents a way to convert paper coupons to electronic and taking the coupon full circle from manufacturer to retailer back to manufacturer for reimbursement to retailer. No other prior art offers such an inclusive coupon management system from beginning of coupon life to end of coupon life.

### Advantages

By using the mobile device and/or kiosk, the consumer can upload/scan coupon into the web application and/or coupon card. The web application and coupon card files the coupon and when appropriate notifies user of expiration. When utilizing coupons, user opens web application from mobile device or presents coupon card at the register, the register scanner will be able to extract all applicable coupons from the web application or coupon card. According to NCH Marketing, 28.3% of consumers do not use coupons because they expire before they could use them. This problem could be lessened with the expiration notification.

The branding implement will limit each coupon to a one-time use. Scanned coupons will not be allowed to be loaded into the account without this branding. This will hinder fraudulent use of paper coupons.

The coupon card and coupon web application allow all coupons to be captured into one place, extracted effortlessly, notifies of expiration and allows better and easier utilization, which will significantly increase the 1% utilization rate of the current 302 billion coupon distribution. Once the coupon gets utilized, it is extracted from the consumer's account.

This process captures all paper coupons and electronic coupons into one application and allows extraction of coupons after utilization.

### SUMMARY

The present embodiments relate generally to the distribution and management of coupons, and more particularly to the branding of paper coupons and converting said paper coupons into electronic coupons via a kiosk, personal scanner, and/or mobile device to be stored in a database and transferred to a coupon card or web application account. After said coupon is utilized, using said database to reimburse retailer from manufacturer.

### BRIEF DESCRIPTION OF THE DRAWINGS

The existing disclosure generally relates to managing both electronic and paper coupons for the purpose of presenting users with a viable way to save on future purchases, organizing them in categories for easier access and ease of use, and providing methods and systems for coupon management systems.

Various embodiments are disclosed in the following brief descriptions and accompanying drawings.

FIG. 1 depicts components for implementing a coupon management system.

FIG. 2 depicts consumer signing up for an account via a website.

FIG. 3 illustrates the process for signing into an account, scanning coupon and/or loading coupons to a coupon card via a kiosk.

FIG. 4 illustrates the uploading of the web application onto the mobile device and example of expiration notification.

FIG. 5 illustrates the process of a mobile device and coupon card interaction with a universal product code (UPC)-type scanner when consumer utilizes coupon at retailer, coupon is removed from account, and consumer receives a print out of the upcoming expiring coupons.

FIG. 6 illustrates the process of a user utilizing the mobile application to trade a coupon with other users via social media as well as posting on social media about mobile web application to receive coupons.

FIG. 7 illustrates the used coupon being stored in a database and assisting a retailer in redeeming coupon from a manufacturer.

### DRAWING REFERENCE NUMERALS

100 Components of the coupon management system
102 Branding tool
104a Paper coupon
104b Electronic coupon
106 Personal digital camera
108 Personal scanner
110 Wireless capable kiosk
112 Mobile device camera
114 Personal Printer
116 Personal Computer
118 Mobile Device
120 Internet
122 Database
124 Coupon card
126 Web Application
128 Utilize Coupon at Register
202 Website Account Sign Up
302 Signing into Account via Kiosk Screen
304 Kiosk Scanner Slot to Scan Paper Coupons
306 Kiosk Coupon Card Insertion
402 Web application expiration notification bubble
502 UPC-type scanner
504 UPC-type scanner scanning web application
506 UPC-type scanner scanning coupon card
508 Printed receipt showing upcoming expiring coupons
602 Sharing/trading coupons via social media
702 Retailer
704 Manufacturer

### DETAILED DESCRIPTION

The various embodiments will be described in detail with reference to the accompanying drawings. The following description of example processes and tools is not intended to limit the scope of the description to the precise method or methods detailed herein. Instead, the following description is intended to be for illustrative purposes and for learning purposes.

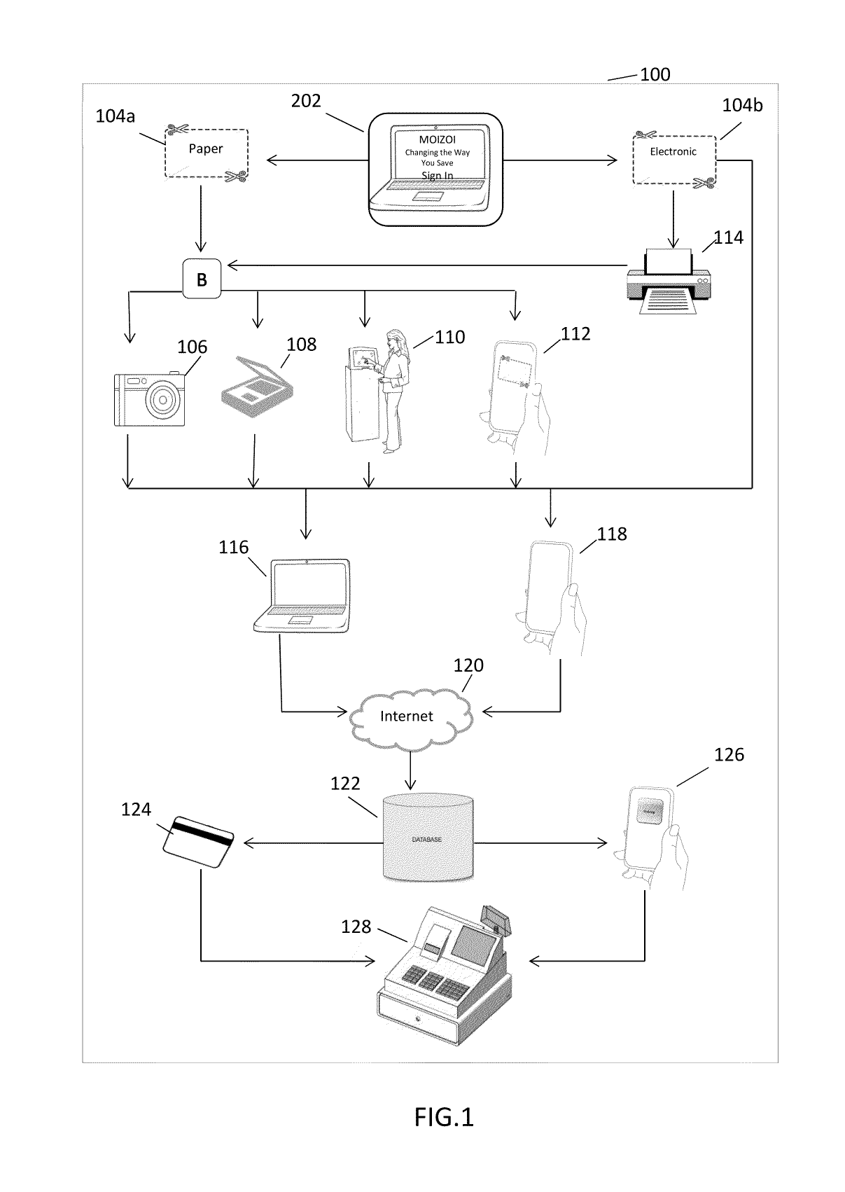

An embodiment illustrated in FIG. 1, depicts components of the coupon management system 100. The consumer signs up for an account on the website 202. Said consumer opens said account 202 by filling in the appropriate information and creating a user name and password. Once signed up, said consumer will receive a branding tool 102 that is used to mark paper coupons 104a to limit said coupon to one time use. The branding tool on FIG. 1 is represented by a letter B. Said consumer can request a coupon card 124 if said consumer prefers not to use a mobile device 118. Said coupon card will be mailed to said consumer to the address provided when said consumer signed up for said account 202. If said consumer chooses to use the mobile application 126, said consumer can load the web application 126 to the mobile device 118. Once said consumer enters said user name and password, said web application 126 is ready for use. Said coupon card 124 and said web application 126 can accept both paper coupons 104a and electronic coupons 104b that have been loaded into said account 202. When said consumer receives a paper coupon 104a, said consumer will use said branding implement 102 to marque paper coupon. The embodiment demonstrates choices that said consumer has—1) take a picture of said paper coupon 104a on either a personal camera 106 or a mobile device camera 112 and load it to said consumer's account 202 via the internet 120 and said paper coupon 104a will be placed in a database 122; 2) use a personal scanner 108 to scan said paper coupon 104a and load it to said consumer's account 202 via the internet 120 and stored in said database 122; or 3) use the kiosk 110 to scan said paper coupon 104a into said consumer's account 202. When said consumer gets an electronic coupon 104b, said consumer has the option to print said electronic coupon 104b on an a personal printer 114 and treat said electronic coupon 104b as a paper coupon 104a as discussed above or said consumer can load said electronic coupon 104b via said internet 120 on a personal computer 116 or a mobile device 118 to be placed in said database 120. Once said electronic coupon 104b has been placed in said database 122, said consumer can go to the retailer and use the web application 126 on the mobile device 118 or the coupon card 124. Said retailer can scan either said web application 126 or said coupon card 124 via a UPC-type scanner 502 and utilized coupons will be deleted from said account 202.

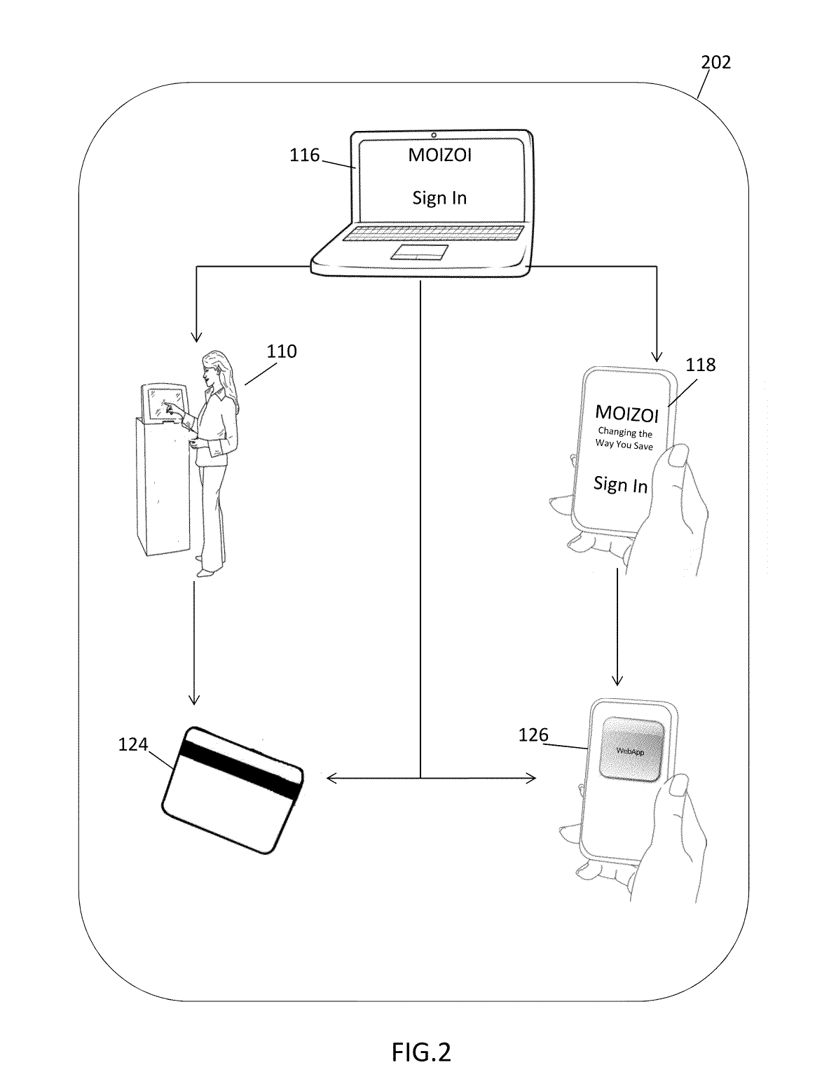

FIG. 2 illustrates the process of signing up for said account 202. Said consumer has two ways that they can sign up for said account—via mobile device 118 or personal computer 116. One of the embodiments of signing up for said account 202 includes a choice of an electronic account to be accessed via said web application 126 or said coupon card 124 to be used with said kiosk 110.

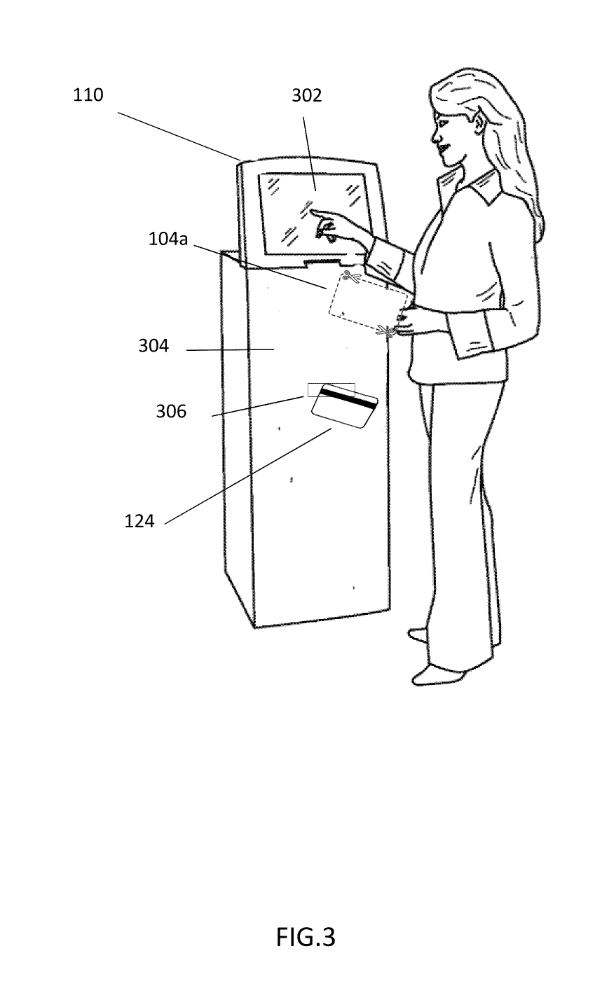

FIG. 3 illustrates said consumer who has said paper coupon 104a and has chosen the kiosk 110 alternative to scan said paper coupon 104a onto said coupon card 124. Said consumer can create said account or said consumer can log into said account 202 via the kiosk screen 302. Once said consumer is logged into said account 202, said consumer will insert said coupon card 124 into the allotted kiosk coupon card slot 306. The consumer will then take said paper coupon 104a and insert said paper coupon 104a into the kiosk scanner slot 304. Said scanner 304 will read the coupon and transmit the information onto said coupon card 124 that has been inserted by said consumer into said kiosk coupon card slot 306. Once scan is complete, said consumer will log out of said account 202 and remove said coupon card 124.

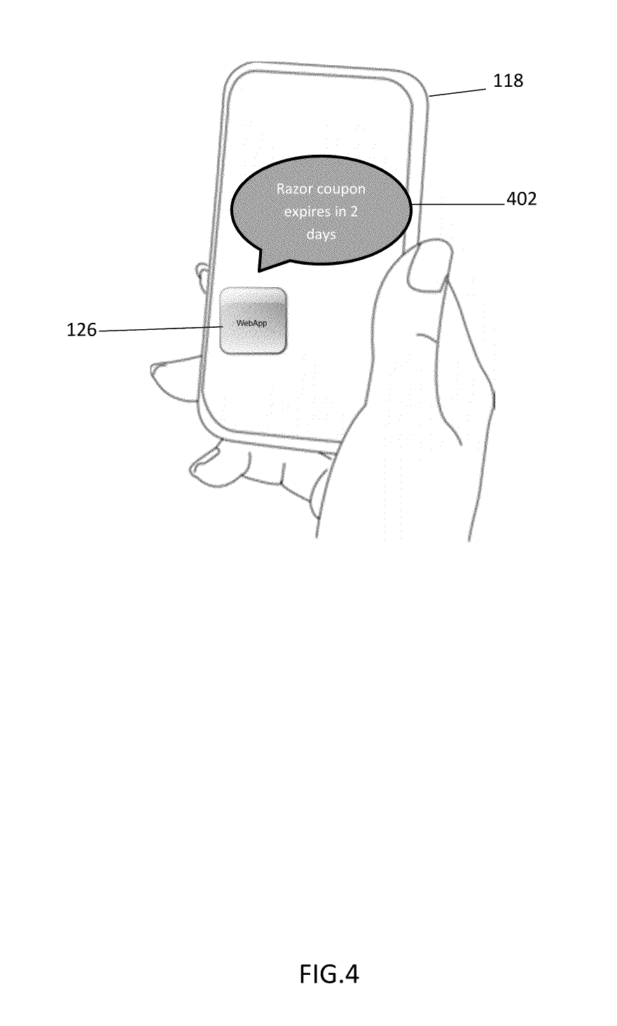

FIG. 4 illustrates said web application notification 402 that said consumer receives when said consumer has loaded said web application 126 onto their mobile device 118. One of the reasons that coupons do not get utilized is because they expire before a consumer can use them. Said web application 126 will provide a means of said web application notification 402 so that said consumer has the opportunity to use said electronic coupon 104b before it expires.

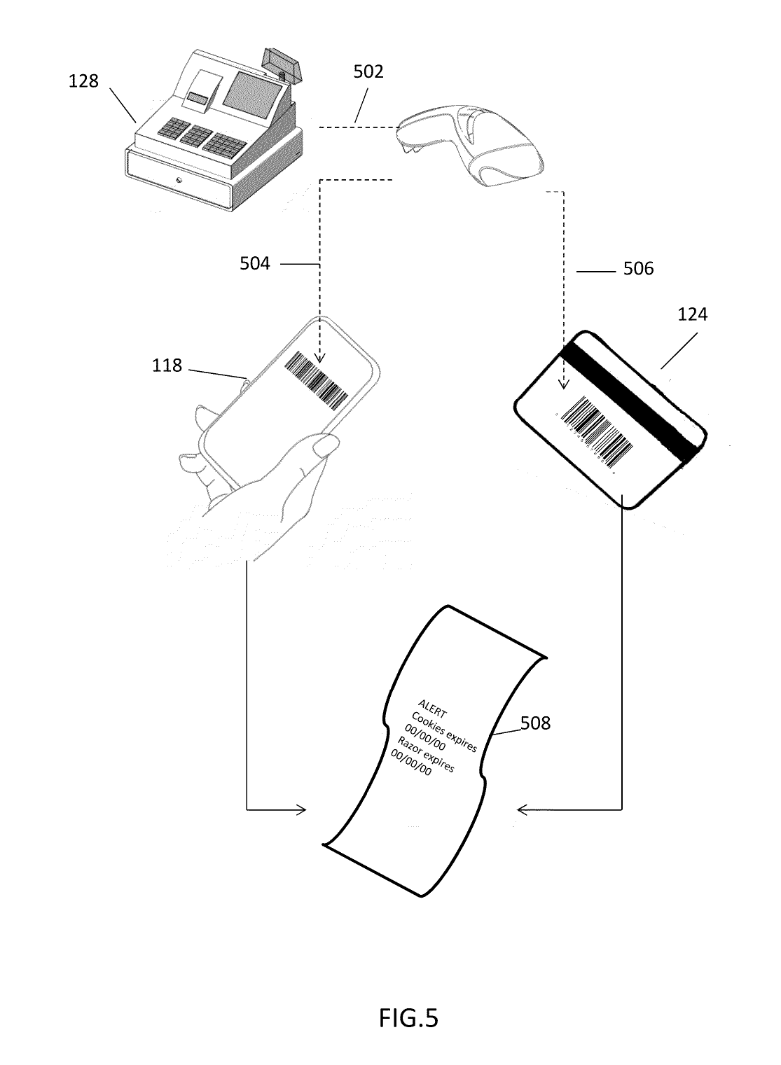

FIG. 5 illustrates said UPC-type scanner 502 at said register 128 of said retailer. When said consumer goes to said register 128, said consumer presents said retailer with said coupon card 124 or said mobile device 118. Said retailer scans all purchases with the UPC-type scanner 502 for the process of using said mobile device 118 504 or for the process of using said coupon card 124 506. Once all purchases have been scanned and all transactions are complete, said retailer will print a receipt. Said printed receipt will show upcoming expiring coupons 508.

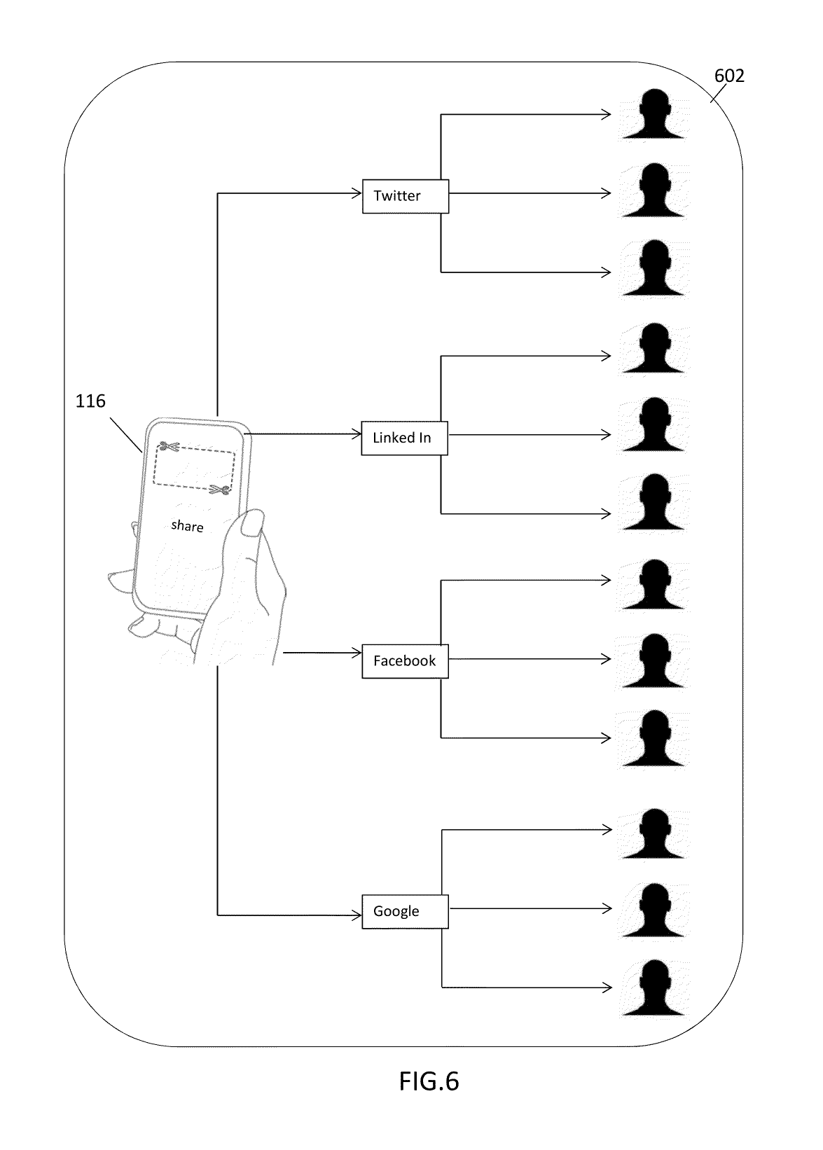

FIG. 6 illustrates an embodiment that allows sharing and trading of said electronic coupons 104b via social media 602. In said consumer's said account, there will be a link provided to give said consumer the ability to share and trade said electronic coupons 104b that are in said account 100 via various social media, such as twitter, linked in, facebook, google, and he like 602.

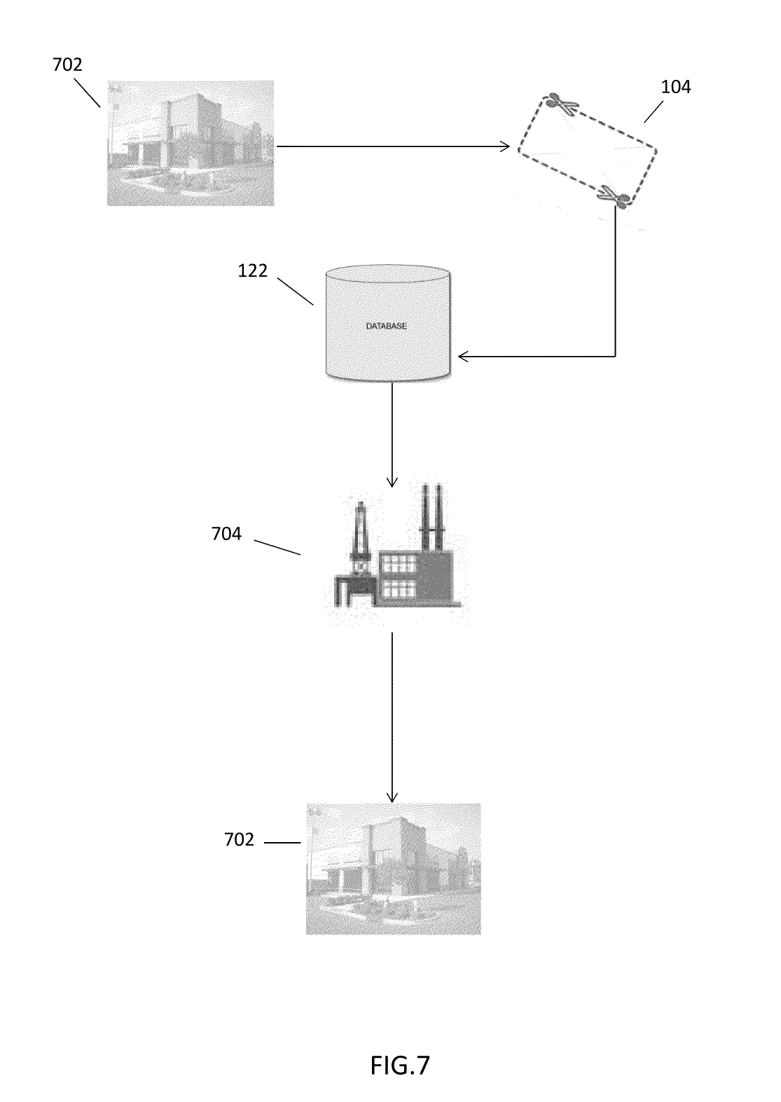

FIG. 7 illustrates an embodiment that will assist said retailer 702 with getting reimbursed for said electronic coupon 104b from the manufacturer 704. As said electronic coupons 104b will be stored in a database 122 after utilization, this implementation will process said electronic coupons 104b for said retailer 702 via electronically. Once processed electronically, the reimbursement will be paid to the retailer 702.

### Operation

In this description, the terms “mobile device” 118 is used to refer to any of a variety of mobile or personal electronic devices including some or all of the capabilities described herein. In particular, these terms may refer to any one or all of cellular telephones, smartphones, laptops, multimedia Internet enabled cellular devices (e.g., iPhone, iPads, iPods, tablets), and similar personal electronic devices.

Paper coupons 104a are normally distributed by print media in newspaper inserts and magazine advertisements, direct mail, and leaflets handed out at retailers. Electronic coupons 104b are distributed through various social media, manufacturers and retailer websites, and email. The process for a consumer of sorting through, clipping, and managing coupons is excessively onerous. Once said paper coupon 104a is scanned upon checkout by a UPC-type scanner 502, a retailer 702 collects the said paper coupons 104a and sends them to a clearinghouse for processing. With said paper coupons 104a, said clearinghouse has to manually sort, count and inventory said paper coupons 104a. Said clearinghouse then creates redemption payment invoices and forwards the invoices and said paper coupons 104a to each manufacturer 704 for reimbursement. Said manufacturer 704 then forwards payment for services to said retailer 702 for the value of said paper coupon 104a plus a handling fee per said paper coupon 104a.

As this process description reveals, trying to keep track of said paper coupons 104a and said electronic coupons 104b can be time consuming and in today's busy lifestyles almost impossible to maintain and manage. Said manufacturer's 704 costs are high to print and distribute approximately 302 billion of said coupons 104a 104b per year with one percent (1%) of those 302 billion said coupons 104a 104b being redeemed. Low said coupon 104a 104b usage is due in part to the fact that people do not have time to clip said paper coupons 104a and said coupons 104a 104b expiring before said consumer can use them.

Said manufacturers 704 are paying excessive amounts for printing and distribution of both said paper coupons 104a and said electronic coupons 104b with very little redemption and said consumers are missing numerous opportunities (approximately 299 billion) to save money.

To assist said manufacturers 704, said retailers 702 and said consumers to navigate the current limitations of the couponing system, the various inclusions provide methods and systems for managing said electronic coupons 104b and said paper coupons 104a by providing a coupon management system 100. By using a web application 126 and/or a coupon card 124, said consumers can take a photo of said paper coupon 104a with said mobile device 118 or scan said paper coupon 104a via a kiosk 110 located at said retailer 702, and load said paper coupon 104a and/or said electronic coupon 104b into said web application 126 or said coupon card 124. Said web application 126 and said coupon card 124 files said electronic coupon 104b and when appropriate notifies user of expiration 402. When utilizing said coupon 104a 104b, user opens said web application 126 at the register, or presents said coupon card 124 at the register, said register's UPC-type scanner 502 will be able to extract all applicable said coupons 104a 104b.

### CONCLUSION, RAMIFICATIONS, AND SCOPE

Accordingly, the reader will see that, according to one embodiment of the invention, we provide a better coupon management system by turning existing paper coupons into electronic coupons. As mentioned above, paper coupons are the largest source of saving money. The process of turning existing paper coupons into electronic coupons allows the current system of distributing coupons via media to stay intact, which means no jobs loss and not changing the way the market works. Furthermore, the coupon management system has the additional advantages in that:
it allows non-technical consumers to benefit from a coupon management system by offering an alternative with the kiosk and coupon card;
it becomes a more well-rounded system by following the coupon from its printed form to electronic form to utilization and on to its reimbursement to retailer from manufacturer;
it provides a way to lessen the fraudulent use of a coupon by utilizing the branding implement;
it provides a notification to consumers of the coupon's pending expiration which is a main cause for consumers not utilizing the coupon; and
it gives the consumer the ability to categorize coupons and manage them more proficiently.

While the above description contains many specificities, these should not be construed as limitations on the scope of any embodiment, but as exemplifications of various embodiments thereof. Many other ramifications and variations are possible within the teachings of the various embodiments.

Thus the scope should be determined by the appended claims and their legal equivalents, and not by the examples given.

We claim:

1. A coupon management system comprising:
a. Said branding/marking said paper coupons
b. Converting said paper coupons to electronic coupons by taking a photograph of said coupon with a photo-capable device, or
c. Scanning said paper coupon
d. Signing up for an account and signing into said account
e. Loading the coupon into database
f. Selecting a coupon card or a mobile device,
g. Said database capable of notifying expiration date
h. Utilizing said coupon via said coupon card or said mobile device
i. Assisting a retailer in obtaining reimbursement from a manufacturer.

2. The coupon management system of claim 1 further comprising providing said branding/marking tool to limit one-time use of said coupon

3. The coupon management system of claim 1 wherein the scanning step is accomplished by using a personal scanner or a kiosk

4. The coupon management system of claim 1 wherein said signing up for and said signing into said account is accomplished by providing a website

5. The coupon management system of claim 1 wherein said signing into said account step is accomplished by using a computer, said kiosk, or said mobile device

6. The coupon management system of claim 1 wherein said loading step is accomplished by said signing into said account

7. The coupon management system of claim 1 wherein the usage of said coupon comprises a scan of universal product code

8. The coupon management system of claim 4 wherein said kiosk will have internet capability

9. The coupon management system of claim 1 wherein said database keeps track of all incoming coupons and ail outgoing coupons

10. The coupon management system of claim 1 wherein said database capable of notifying of expiration date of said coupon is accomplished by receipt printout at retailer or online account notification

11. The coupon management system of claim 1 wherein assisting said retailer is accomplished by utilizing said database

12. A coupon management system comprising:
a. Obtaining said paper coupons from various media
b. Branding/marking said paper coupons
c. Converting said paper coupon into an electronic coupon
d. Loading said electronic coupon into said database
e. Database notifying capability of said electronic coupon expiration
f. Database acknowledging said electronic coupon usage
g. Utilizing said database to seek reimbursement for said retailer from said manufacturer

13. The coupon management system in claim 12 wherein said paper coupons can be obtained from newspapers, magazines, inserts, flyers, retailer receipts, mailers, and the like

14. The coupon management system in claim 12 wherein said branding/marking includes any logo, number, combination logo number, or identifying marking

15. The coupon management system in claim 12 wherein converting said paper coupons is accomplished by a photo-capable device

16. The coupon management system in claim 12 wherein said electronic coupons includes converted said paper coupons as well as any said electronic coupon obtained via online

17. The coupon management system in claim 12 wherein said database tracks used and unused said electronic coupons

18. The coupon management system in claim 12 wherein said reimbursement to said retailer is accomplished by utilizing said database and electronically notifying said manufacturer of said coupon usage
